(19) United States
(12) Patent Application Publication
(10) Pub. No.: US 2020/0031984 A1
(43) Pub. Date: Jan. 30, 2020

(54) RESIN PARTICLES FOR ADDITION TO SURFACE PROTECTIVE RESIN MEMBER AND SURFACE PROTECTIVE RESIN MEMBER

(71) Applicant: FUJI XEROX CO., LTD., Tokyo (JP)

(72) Inventors: Yoshihiro INABA, Kanagawa (JP); Hisae YOSHIZAWA, Kanagawa (JP)

(73) Assignee: FUJI XEROX CO., LTD., Tokyo (JP)

(21) Appl. No.: 16/374,777

(22) Filed: Apr. 4, 2019

(30) Foreign Application Priority Data
Jul. 26, 2018 (JP) 2018-140583

(51) Int. Cl. C08G 18/62; C08G 18/73; C08G 18/75; C08G 18/42; C09D 175/04; C09D 7/65; C09D 7/40

(52) U.S. Cl. CPC C08G 18/6229; C08G 18/73; C08G 18/755; C08G 18/4277; C08K 5/0075; C09D 7/65; C09D 7/69; C09D 7/70; C09D 175/04

(57) ABSTRACT

Resin particles for addition to a surface protective resin member include an acrylic-urethane resin as a main component. The resin particles have a Martens hardness at 23° C. in a range of 0.5 N/mm² to 220 N/mm², a recovery ratio at 23° C. in a range of 70% to 100%, and a volume average particle size D50v in a range of 3 μm to 50 λm.

### CROSS-REFERENCE TO RELATED APPLICATIONS

This application is based on and claims priority under 35 USC 119 from Japanese Patent Application No. 2018-140583 filed Jul. 26, 2018.

### BACKGROUND

### (i) Technical Field

The present disclosure relates to resin particles for addition to a surface protective resin member, and a surface protective resin member.

### (ii) Related Art

In order to suppress generation of surface scratches in various technical fields, surface protective resin members such as surface protective films have been disposed. In particular, for example, when interior materials, furniture, or leather materials are equipped with surface protective resin members, from the viewpoint of providing, for example, luxuriousness, the surface protective resin members may be designed to have reduced surface glossiness. The reduced surface glossiness may be achieved by adding particles of, for example, a matting agent to surface protective resin members.

For example, Japanese Laid Opened Patent Application Publication No, 4-82736 discloses a sueded sheet in which, on a base sheet having a wetting index in a range of 38 to 60 dyne/cm, a coating film is formed from a matting coating material prepared by adding a bead pigment and/or synthetic resin beads to a vehicle of two-part curable resin.

Japanese Laid Opened Patent Application Publication. No. 5-302062 discloses a decorative attachable coating resin composition containing, as essential coating forming components, polyurethane polyurea particles having a three-dimensional crosslinked structure, and a binder resin.

Japanese Laid Opened Patent Application Publication No. 5-254072 discloses a matte-color resin sheet in which, on a colored resin sheet, a coating film of a polyurethane resin containing amino acid resin particles is formed, the matte-color resin sheet having a surface providing a smooth texture.

Japanese Laid Opened Patent Application Publication No. 2-64166 discloses a matte coating material containing a powder as a component such that the powder forms irregularities in the coating film to provide a matte surface of the coated article, wherein the matte coating material contains a polyurethane resin in an amount of 1 to 20 times the weight of the powder.

Japanese Laid Opened Patent Application Publication No. 8-209029 discloses a matting agent for a coating material, the matting agent being composed of silica or silicate in an oxide-based weight ratio of SiO₂:MO=100:0 or 50:50 (where M represents a group II metal in the periodic table), wherein spherical silica or silicate particles are amorphous or fine layered crystalline in X-ray diffractometry; the particles individually independently have a clearly defined spherical shape; particles having a sphericity of 0.8 to 1.0 account for 80% or more of the particles, the sphericity being represented by a ratio (Dₛ/D_{L}) of the short diameter (Dₛ) to the long diameter (D_{L}) of the particles; the particles have a particle size distribution having a sharpness of 1.2 to 2. 0 and defined with formula (1) (D₂₅/D₇₅) (where, in a volume-based cumulative particle-size-distribution curve drawn by a COULTER COUNTER method, D₂₅ represents a particle size at a cumulative value of 25%, and D₇₅ represents a particle size at a cumulative value of 75%); and the particles have a BET specific surface area of 30 to 800 m²/g.

Japanese Laid Opened Patent Application Publication No. 9-157545 discloses a matting agent for a coating material, the matting agent including aggregate having an oil absorption amount of less than 80 ml/100 g and having a size of less than 100 μm, and hydrophobic silica.

Japanese Laid Opened Patent Application. Publication No. 5-132636 discloses a method for forming a coating film by applying a coating material, wherein the coating material containing crosslinking elastic resin fine particles as an essential component of a film-forming resin is applied and dried or cured to form a hard and flexible coating film.

Japanese Laid Opened Patent Application Publication No. 2007-262248 discloses an aqueous matte coating agent composed of 100 parts by weight of solid content of an aqueous polyurethane resin, and 50 to 300 parts by weight of crosslinked spherical organic resin fine particles.

### SUMMARY

Surface protective resin members disposed on the surfaces of substrates to protect the surfaces are designed to have scratch resistance (such as self-healing properties of healing scratches temporarily generated therein). In some cases, surface protective resin members are provided so as to contain particles of, for example, a matting agent. Addition of such particles may cause degradation of scratch resistance. Thus, there has been a demand for particles that are added to a surface protective resin member, but that does not cause serious degradation of scratch resistance.

Aspects of non-limiting embodiments of the present disclosure relate to resin particles that are added to form a surface protective resin member having high scratch resistance, compared with resin particles that satisfy at least one of a feature of a Martens hardness at 23° C. of more than 220 N/mm² and a feature of a recovery ratio at 23° C. of less than 70%.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided resin particles for addition to a surface protective resin member, the resin particles including an acrylic-urethane resin as a main component, the resin particles having a Martens hardness at 23° C. in a range of 0.5 N/mm² to 220 N/mm², a recovery ratio at 23° C. in a range of 70% to 100%, and a volume-average particle size D50v in a range of 3 μm to 50 μm.

### DETAILED DESCRIPTION

Hereinafter, exemplary embodiments according to the present disclosure will be described. However, the exemplary embodiments are mere examples for practicing the present disclosure, and the present disclosure is not limited to the following exemplary embodiments.

### Resin Particles for Addition to Surface Protective Resin Member

Resin particles for addition to a surface protective resin member (hereafter, also simply referred to as “resin particles”) according to an exemplary embodiment include an acrylic-urethane resin as a main component, and have a Martens hardness at 23° C. of 0.5 N/mm² or more and 220 N/mm² or less, a recovery ratio at 23° C. of 70% or more and 100% or less, and a volume-average particle size D50v of 3 μm or more and 50 μm or less.

The “main component” of the resin particles is the highest mass content component of the resin particles. The acrylic-urethane resin content of the resin particles is preferably 50 mass % or more, more preferably 60 mass % or more.

In these years, in order to suppress generation of surface scratches, surface protective resin members such as surface protective films have been disposed on the surfaces of various articles. In general, surface protective resin members often have high surface glossiness. Thus, when surface protective resin members are disposed on the surfaces of, for example, interior materials, furniture, or leather materials, the surface protective resin members are designed to have lower glossiness. In order to achieve lower glossiness, for example, there is a known technique of adding particles referred to as a matting agent to surface protective resin members. Examples of the matting agent include synthetic resin particles and inorganic particles.

However, when existing particles such as synthetic resin particles or inorganic particles are added to a surface protective resin member constituted by a continuous phase of resin having scratch resistance (such as self-healing properties), the scratch resistance may be degraded. In particular, when the particle content is 20 mass % or more, serious degradation of scratch resistance occurs. The probable mechanism of this phenomenon is as follows. With an increase in the amount of particles added, the content ratio of the resin forming the continuous phase decreases; in addition, interfaces are formed between the added particles and the continuous phase of the resin, and the presence of the interfaces considerably affects scratch resistance (such as self-healing properties).

By contrast, resin particles according to an exemplary embodiment have features of including an acrylic-urethane resin as a main component, and having a Martens hardness at 23° C. of 0.5 N/mm² or more and 220 N/mm² or less, a recovery ratio at 23° C. of 70% or more and 100% or less, and a volume-average particle size D50v of 3 μm or more and 50 μm or less. The exemplary embodiment is based on the findings that, when these resin particles having the features are added to a surface protective resin member, in spite of the presence of interfaces between the resin particles and the resin (resin having scratch resistance) forming the continuous phase, high scratch resistance (such as self-healing properties) is provided.

Hereinafter, the resin particles for addition to a surface protective resin member according to this exemplary embodiment will be described in detail.

### Properties of Resin Particles

### Martens Hardness

The resin particles according to this exemplary embodiment have a Martens hardness at 23° C. of 0.5 N/mm² or more and 220 N/mm² or less, preferably 1 N/mm² or more and 80 N/mm² or less, more preferably 1 N/mm² or more and 5 N/mm² or less.

When the Martens hardness (23° C.) is 220 N/mm² or less, the resin particles added to a surface protective resin member provide a surface protective resin member having high scratch resistance (such as self-healing properties). On the other hand, when the Martens hardness (23° C.) is 0.5 N/mm² or more, the resin particles tend to maintain the designed shape.

### Recovery Ratio

The resin particles according to this exemplary embodiment have a recovery ratio at 23° C. of 70% or more and 100% or less, preferably 80% or more and 100% or less, more Preferably 90% or more and 100% or less.

The recovery ratio is an index of self-healing properties (properties of recovering from strain (caused by application of a stress) within 1 min after removal of the stress, namely the degree of healing scratches) of resin particles. Specifically, when the recovery ratio (23° C.) is 70% or more, the probability of healing scratches (namely, self-healing properties) is improved; thus, these resin particles added to a surface protective resin member provide a surface protective resin member having high scratch resistance (such as self-healing properties).

The Martens hardness and recovery ratio of the resin particles are measured with an instrument, FISCHERSCOPE HM2000 (manufactured by Fischer). A sample is fixed on a slide glass with an adhesive, and mounted on the instrument. To the sample, a load applied is increased to 0.5 mN over a period of 15 seconds at a predetermined measurement temperature (for example, 23° C.), and the load of 0.5 mN is maintained for 5 seconds. In this process, the maximum displacement is measured as h1. Subsequently, the load is decreased to 0.005 mN over a period of 15 seconds, and the load of 0.005 mN is maintained for 1 minute during which the displacement is measured as h2. From h1 and h2, the recovery ratio is calculated using [(h1−h2)/h1]×100 (%). In this measurement, a load-displacement curve is created, and this curve is used to determine Martens hardness.

In this measurement, when the resin particles have such a size that the load is directly applied to a resin particle with an indenter of the instrument, the resin particle itself (a single resin particle) is used as the sample. On the other hand, when the resin particles have such a size that the load cannot be directly applied to a resin particle with the indenter, the components of the resin particles are analyzed and the same components are used to form a resin film (average thickness: 5 μm), and this resin film is used as the sample.

In general, the indenter is used to directly apply the load to resin particles that have a volume-average particle size D50v of 10 or more.

The Martens hardness and recovery ratio of the resin particles can be controlled by adjusting the composition of the acrylic-urethane resin, which is the main component of the resin particles. For example, when the acrylic-urethane resin is a reaction product of a hydroxyl-group-containing acrylic resin (a), a polyol (b) having plural hydroxyl groups linked together via a carbon chain having 6 or more carbon atoms, and a multifunctional isocyanate (c), the Martens hardness and recovery ratio can be controlled by adjusting, for example, the following parameters: the hydroxyl value of the acrylic resin (a), the number of carbon atoms of the carbon chain linking together hydroxyl groups in the long-chain polyol (b), the ratio of the long-chain polyol (b) to the acrylic resin (a), the number of functional groups (isocyanate groups) in the multifunctional isocyanate (c), or the ratio of the multifunctional isocyanate (c) to the acrylic resin (a).

### Volume-Average Particle Size D50v

The resin particles according to this exemplary embodiment have a volume-average particle size D50v of 3 μm or more and 50 μm or less, preferably 4 μm or more and 40 μm or less, more preferably 5 μm or more and 30 μm or less.

When the volume-average particle size D50v is 3 μm or more, the effects (such as reduction in glossiness) provided by addition of the resin particles to a surface protective resin member are improved. On the other hand, when the volume-average particle size D50v is 50 μm or less, the resin particles added to a surface protective resin member provide a surface protective resin member having high scratch resistance (such as self-healing properties).

### Volume-Based Particle-Size-Distribution Index GSDv

The resin particles according to this exemplary embodiment preferably have a volume based particle size distribution index GSDv of 1.0 or more and 1.5 or less, more preferably 1.1 or more and 1.4 or less, still more preferably 1.1 or more and 1.3 or less.

When the volume based particle size distribution index GSDv is 1.5 or less, the resin particles have a relatively narrow particle size distribution; as a result, the resin particles added to a surface protective resin member tend to provide a surface protective resin member having high scratch resistance (such as self-healing properties). On the other hand, when the volume based particle size distribution index GSDv is 1.0 or more, the resin particles may be monodispersed particles having the same particle size (where GSD=1.0), or may have a wider distribution than that of the monodispersed particles; in this case, the resin particles are easily produced.

The volume average particle size D50v and volume based particle size distribution index GSDv of the resin particles are measured with a COULTER MULTISIZER II (manufactured by Beckman Coulter, Inc.) and an electrolyte ISOTON-II (manufactured by Beckman Coulter, Inc.).

In the measurement, in a dispersing agent that is 2 ml of a 5% aqueous solution of a surfactant (preferably sodium alkylbenzene sulfonate), 0.5 mg or more and 50 mg or less of the measurement sample is added. The resultant dispersion is added to 100 ml or more and 150 ml or less of the electrolyte.

The electrolyte in which the sample has been suspended is subjected to dispersion treatment with an ultrasonic dispersing device for 1 minute. The COULTER MULTISIZER II is used to measure the particle size distribution of particles having a particle size in a range of 2 μm or more and 60 μm or less, through an aperture having an aperture size of 100 μm. Incidentally, the number of particles sampled is 50000.

The particle size distribution measured is divided into particle size ranges (channels). Over these channels, a volume based cumulative curve is drawn from smaller to larger particle sizes. A particle size corresponding to a cumulative value of 16% is defined as volume based particle size D16v. A particle size corresponding to a cumulative value of 50% is defined as volume average particle size D50v. A particle size corresponding to a cumulative value of 84% is defined as volume based particle size D84v.

From D84v and D16v, the volume based particle size distribution index (GSDv) is calculated using (D84v/D16v)^{1/2}.

### Average Circularity

The resin particles according to this exemplary embodiment preferably have an average circularity of 0.8 or more and 1.0 or less, more preferably 0.85 or more and 1.0 or less, still more preferably 0.9 or more and 1.0 or less.

When the resin particles have an average circularity of 1.0 or less, the particles may have a spherical shape (where the circularity=1.0), or may have a non-spherical and relatively distorted shape; in such cases, the resin particles provide high coatability in formation of a coating film. On the other hand, when the resin particles have an average circularity of 0.8 or more, the particles are not excessively distorted; in such cases, the resin particles added to a surface protective resin member tend to provide a surface protective resin member having high scratch resistance (such as self-healing properties).

The average circularity of resin particles is calculated using (circumferential length of equivalent circle)/(peripheral length) [(circumferential length of a circle having the same projection area as the image of a particle)/(peripheral length of the projected image of the particle)]. Specifically, the average circularity is calculated in the following manner.

The average circularity is determined with a flow particle image analyzer (FPIA-3000, manufactured by SYSMEX CORPORATION) in which the resin particles to be measured are first taken in by suction; the resin particles are made to form a flat flow; the flat flow is exposed to light emitted for a very short period from a stroboscope and still pictures are taken as images of the particles; and the images of the particles are subjected to image analysis. In the determination of the average circularity, the number of the particles sampled is 3500.

### Composition of Resin Particles

The resin particles according to this exemplary embodiment include an acrylic-urethane resin as the main component.

The acrylic-urethane resin; is a resin including urethane bonds (—NHCOO—) and, in the molecular structure, a segment derived from an acrylic resin provided by polymerizing a polymerizable monomer group that includes at least an acrylic monomer (such as a monomer represented by Formula (ac) below and that optionally includes a monomer including a vinyl group (such as a group represented by ( R^{B})₂—C═C—(R^{B})— where R^{B}'s each independently represent a hydrogen atom, a fluorine atom, or an alkyl group having 1 or more and 8 or less carbon atoms (such as a methyl group or an ethyl group)).

(Rac¹-)₂C═C(-Rac^{l})(—COO-Rac²) Formula ac:

In Formula ac, Rac¹'s each independently represent a hydrogen atom or an alkyl group having 1 or more and 8 or less carbon atoms (such as a methyl group or an ethyl group), Rac² represents an organic group. This organic group is, for example, an organic group including at least one atom species selected from the atom group consisting of C, H, O, and N. Examples of the organic group include hydrocarbon groups (such as alkyl groups and aryl groups) and alkyl fluoride groups (such as perfluoroalkyl groups). The hydrocarbon groups and alkyl fluoride groups may further include a substituent or a hetero atom (such as —OH, —O—, —C(αO)—, or —C(═O)—O—).

In this exemplary embodiment, the resin particles include an acrylic-urethane resin as the main component. The acrylic-urethane resin content relative to the entirety of the resin particles is preferably 50 mass % or more and 100 mass % or less, more preferably 60 mass % or more and 100 mass % or less.

The acrylic-urethane resin is obtained by, for example, a reaction of an acrylic resin having hydroxyl groups in the molecular structure (hydroxyl-group-containing acrylic resin)(a), and a multifunctional isocyanate (c) having plural isocyanate groups.

From the viewpoint of adding resin particle to obtain a surface protective resin member having high scratch resistance (such as self-healing properties), the acrylic-urethane resin is preferably a reaction product of the hydroxyl-group-containing acrylic resin (a), a polyol (long chain polyol) (b) having plural hydroxyl groups linked together via a carbon chain having 6 or more carbon atoms, and the multifunctional isocyanate (c).

From the viewpoint of scratch resistance (such as self-healing properties) of the surface protective resin member, the acrylic-urethane resin is more preferably a reaction product of a polymerizable component group in which the above-described components (a), (b), and (c) in total account for 90 mass % or more of all the polymerizable components.

### Hydroxyl-Group-Containing Acrylic Resin (a)

In this exemplary embodiment, a starting material of the acrylic-urethane resin is a hydroxyl-group-containing acrylic resin (a), which has hydroxyl groups (—OH), Incidentally, the hydroxyl groups (—OH) in the hydroxyl-group-containing acrylic resin (a) may have the form of a carboxy group (—COOH).

The hydroxyl groups are introduced, for example, in the following mariner: a polymerizable monomer having a hydroxyl group is employed as a polymerizable monomer for forming the hydroxyl-group-containing acrylic resin (a).

Examples of the polymerizable monomer having a hydroxyl group include (1) an ethylenically polymerizable monomer having a hydroxyl group such as hydroxymethyl (meth)acrylate, hydroxyethyl (meth)acrylate, hydroxypropyl (meth)acrylate, hydroxybutyl (meth)acrylate, or N-methylolacrylamine.

Other examples include (2) an ethylenically polymerizable monomer having a carboxy group such as (meth)acrylic acid, crotonic acid, itaconic acid, fumaric acid, or maleic acid.

The polymerizable monomer for forming the hydroxyl-group-containing acrylic resin (a) may be used in combination with a polymerizable monomer not having a hydroxyl group. Examples of the polymerizable monomer not having a hydroxyl group include ethylenically polymerizable monomers that are copolymerizable with the polymerizable monomers (1) and (2): (meth)acrylic acid alkyl esters such as methyl (meth)acrylate, ethyl (meth)acrylate, propyl (meth)acrylate, butyl (meth)acrylate, n-propyl (meth)acrylate, n-butyl (meth)acrylate, isobutyl (meth)acrylate, 2-ethylhexyl (meth)acrylate, n-octyl (meth)acrylate, and n-dodecyl (meth)acrylate; vinyl halides such as vinyl chloride and vinyl bromide; vinyl cyanides such as acrylonitrile and methacrylonitrile; vinyl esters such as vinyl formate, vinyl acetate, and vinyl propionate; aromatic vinyl derivatives such as styrene, vinyltoluene, and α-methylstyrene; vinylidene halides such as vinylidene chloride and vinylidene fluoride; acrylic acid and salts thereof such as acrylic acid, sodium acrylate, and calcium acrylate; acrylic acid alkyl ester derivatives such as β-hydroxyethyl acrylate, dimethylaminoethyl acrylate, glycidyl acrylate, acrylamide, and N-methylolacrylamide; methacrylic acid and salts thereof such as methacrylic acid, sodium methacrylate, and calcium methacrylate; methacrylic acid alkyl ester derivatives such as methacrylamide, β-hydroxyethyl methacrylate, dimethylaminoethyl methacrylate, and glycidyl methacrylate; and acid anhydrides and imides such as maleic anhydride, methylmaleimide, and phenylmaleimide.

In this Specification, “(meth)acrylic acid” encompasses both of acrylic acid and methacrylic acid; “(meth)acrylate” encompasses both of acrylate and methacrylate.

The hydroxyl-group-containing acrylic resin (a) may be, for example, a reaction product of a polymerizable monomer group including at least an acrylic monomer and optionally a monomer having a vinyl group. This reaction product includes a main chain formed by polymerization of the ethylenically double bond moieties of polymerizable monomers, and side chains bonding to the main chain.

A case will be described where the acrylic-urethane resin included in the resin particles is a reaction product of the hydroxyl-group-containing acrylic resin (a), the long-chain polyol (b), and the multifunctional isocyanate (c). In this hydroxyl-group-containing acrylic resin (a), among all the side chains having hydroxyl groups, the content ratio (molar ratio) of side chains each having a hydroxyl group and 10 or more carbon atoms (carbon atoms in the side-chain moiety) (hereafter, also referred to as “long-side-chain hydroxyl groups”) to side chains each having a hydroxyl group and less than 10 carbon atoms (carbon atoms in the side-chain moiety) (hereafter, also referred to as “short-side-chain hydroxyl groups”) may be less than 1/3.

Even when, in the hydroxyl-group-containing acrylic resin (a), the ratio of the long-side-chain hydroxyl groups to the short-side-chain hydroxyl groups is less than 1/3, in other words, the long-side-chain hydroxyl groups are fewer than the short-side-chain hydroxyl groups, the long-chain polyol (b) is additionally used, so that the acrylic-urethane resin tends to have an increased recovery ratio and a decreased Martens hardness. Thus such resin particles added to a surface protective resin member tend to provide a surface protective resin member having high scratch resistance (such as self-healing properties). Incidentally, as the amount of long-chain polyol (b) increases, the acrylic-urethane resin tends to have a higher recovery ratio and a lower Martens hardness.

The number of carbon atoms of the side-chain moiety containing the short-side-chain hydroxyl group is less than 10, preferably 6 or less. The number of carbon atoms of the side-chain moiety containing the long-side-chain hydroxyl group is 10 or more, preferably 15 or more.

Examples of a polymerizable monomer for introducing the short-side-chain hydroxyl group include hydroxymethyl (meth)acrylate, hydroxyethyl (meth)acrylate, hydroxypropyl (meth)acrylate, hydroxybutyl (meth)acrylate, N-methylolacrylamine, (meth)acrylic acid, crotonic acid, itaconic acid, fumaric acid, and maleic acid.

Examples of a polymerizable monomer for introducing the long-side-chain hydroxyl group include an ε-lactone ring-opened monomer that tends to provide increased elasticity, for example, preferably a monomer obtained by adding 3 moles or more and 5 moles or less of ε-caprolactone to 1 mole of hydroxymethyl (meth)acrylate.

Incidentally, for each of the short-side-chain hydroxyl group and the long-side-chain hydroxyl group, the side-chain moiety may include no fluorine atom.

### Fluorine Atom

The hydroxyl-group-containing acrylic resin (a) is preferably an acrylic resin containing fluorine atoms. When the hydroxyl-group-containing acrylic resin (a) contains fluorine atoms in the molecular structure, formability of the particulate shape of resin particles tends to be improved.

Fluorine atoms are introduced into the hydroxyl-group-containing acrylic resin (a) by, for example, employing, as a polymerizable monomer for forming the hydroxyl-group-containing acrylic resin (a), a polymerizable monomer containing a fluorine atom. Specifically, fluorine atoms may be introduced with a polymerizable monomer having a fluorine-atom-containing group and a vinyl group.

The vinyl group is represented by a structural formula (R^{B}—)₂C═C(—R^{B})— where R^{B}'s each independently represent a hydrogen atom, a fluorine atom, or an alkyl group having 1 or more and 8 or less carbon atoms. R^{B} is preferably a hydrogen atom, a fluorine atom, or a methyl group. In this Specification, examples of the vinyl group include CH₂λCH—, CH₂═C(CH₃)—, and CF₂═CF—.

The polymerizable monomer having a fluorine-atom-containing group and a vinyl group may be selected from known monomers. Specific examples include trifluoromethyl (meth)acrylate, 2,2,2-trifluoroethyl (meth)acrylate, 1,1,1,3,3, -hexafluoro-2-propyl (meth)acrylate, perfluoroethylmethyl (meth)acrylate, perfluoropropylmethyl (meth)acrylate, polyperfluorobutylmethyl (meth)acrylate, perfluoropentylmethyl (meth)acrylate, perfluorohexylmethyl (meth)acrylate, perfluoroheptylmethyl (meth)acrylate, perfluorooctylmethyl (meth)acrylate, perfluorononylmethyl (meth)acrylate, perfluorodecylmethyl (meth)acrylate, perfluoroundecylmethyl (meth)acrylate, perfluorododecylmethyl (meth)acrylate, perfluorotridecylmethyl (meth)acrylate, perfluorotetradecylmethyl (meth)acrylate, 2-(trifluoromethyl)ethyl (meth)acrylate, 2-(perfluoroethyl)ethyl (meth)acrylate, 2-(perfluoropropyl)ethyl (meth)acrylate, 2-(perfluorobutyl)ethyl (meth)acrylate, 2-(perfluoropentyl)ethyl (meth)acrylate, 2-(perfluorohexyl)ethyl (meth)acrylate, 2-(perfluoroheptyl)ethyl (meth)acrylate, 2-(perfluorootyl)ethyl (meth)acrylate, 2-(perfluorononyl)ethyl (meth)acrylate, 2-(perfluorotridecyl)ethyl (meth)acrylate, 2-(perfluorotetradecyl)ethyl (meth)acrylate, perfluorohexylethylene, hexafluoropropene, hexafluoropropene epoxide, and perfluoro(propyl vinyl ether).

In the hydroxyl-group-containing acrylic resin (a), fluorine-atom-containing side chains preferably have no groups that react with the long-chain polyol (b) and the multifunctional isocyanate (c). Thus, the fluorine-atom-containing polymerizable monomer for forming the hydroxyl-group-containing acrylic resin (a) is preferably a polymerizable monomer including no groups reactive to (b) and (c), or including, after polymerization, no groups reactive to (b) and (c).

The fluorine-atom-containing side chains may have 2 or more and 20 or less carbon atoms, for example. The fluorine-atom-containing side chains may be linear or branched carbon chains.

The number of fluorine atoms contained in a single molecule of the fluorine-atom-containing polymerizable monomer is not particularly limited, but is preferably, for example, 1 or more and 25 or less, more preferably 3 or more and 17 or less.

In the resin particles according to this exemplary embodiment, the fluorine atom content relative to the entire resin particles is preferably 0.5 mass % or more and 15 mass % or less, more preferably 1 mass % or more and 10 mass % or less, still more preferably 2 mass % or more and 10 mass % or less.

When the fluorine atom content is 0.5 mass % or more, the formability of the particulate shape of resin particles tends to be improved. On the other hand, when the fluorine atom content is 15 mass % or less, the resin particles added to a surface protective resin member tend to provide a surface protective resin member having high scratch resistance (such as self-healing properties).

The fluorine atom content of the resin particles can be controlled by changing, for example, a ratio of the fluorine-atom-containing polymerizable monomer relative to all the polymerizable monomers for synthesizing the hydroxyl- group-containing acrylic resin (a), or a ratio of the hydroxyl-group-containing acrylic resin (a) and other components (such as the long-chain polyol (b) and the multifunctional isocyanate (c)).

The fluorine atom content of the resin particles is measured by X-ray photoelectron spectroscopy (XPS) while the resin particles are etched with argon gas clusters.

### Hydroxyl Value

The hydroxyl-group-containing acrylic resin (a) preferably has a hydroxyl value of 40 mgKOH/g or more and 280 mgKOH/g or less, more preferably 70 mgKOH/g or more and 200 mgKOH/g or less

When the hydroxyl value is 40 mgKOH/g or more, polymerization provides an acrylic-urethane resin having a high crosslink density. As a result, the resin particles added to a surface protective resin member tend to provide a surface protective resin member having high scratch resistance (such as self-healing properties). On the other hand, when the hydroxyl value is 280 mgKOH/g or less, an acrylic-urethane resin having appropriate flexibility is obtained.

The hydroxyl value of the hydroxyl-group-containing acrylic resin (a) can be adjusted by changing, for example, the ratio of a hydroxyl-group-containing, polymerizable monomer to all the polymerizable monomers for synthesizing the hydroxyl-group-containing acrylic resin (a).

The hydroxyl value is the number of milligrams of potassium hydroxide for achieving acetylation of hydroxyl groups in 1 g of the sample. In this exemplary embodiment, the hydroxyl value is measured in accordance with a method (potentiometric titration) defined in JIB K0070-1992. When the sample does not dissolve, a solvent such as dioxane or tetrahydrofuran (THF) is used.

### Molecular Weight

The hydroxyl-group-containing acrylic resin (a) preferably has a weight-average molecular weight of 5000 or more and 100000 or less, more preferably 10000 or more and 50000 or less.

When the hydroxyl-group-containing acrylic resin (a) has a weight average molecular weight of 5000 or more, the resin particles added to a surface protective resin member tend to provide a surface protective resin member having high scratch resistance (such as self-healing properties). On the other hand, when the weight average molecular weight is 100000 or less, resin particles having high flexibility tend to be obtained.

The weight average molecular weight of the hydroxyl-group-containing acrylic resin (a) is measured by gel permeation chromatography (GPC). The molecular weight measurement by GPC is performed with a measurement apparatus GPC HLC-8120GPC manufactured by Tosoh Corporation, a column TSKGEL SUPERHM-M (15 cm) manufactured by Tosoh Corporation, and tetrahydrofuran (THF) solvent. The weight average molecular weight is calculated from the measurement results with a molecular weight calibration curve created with monodisperse polystyrene standards.

The hydroxyl-group-containing acrylic resin (a) synthesized by, for example, mixing the above-described polymerizable monomers, subjecting the monomers to standard radical polymerization or ionic polymerization, and subsequently purifying the resultant product.

### Long-Chain Polyol (b)

The long-chain polyol has plural hydroxyl groups (—OH) linked together via a carbon chain having 6 or more carbon atoms (carbon atoms of a linear moiety linking hydroxyl groups together). In other words, in the long-chain polyol, all the hydroxyl groups are linked together via a carbon chain having 6 or more carbon atoms (carbon atoms of a linear moiety linking hydroxyl groups together).

The number of functional groups in the long-chain polyol (in other words, the number of hydroxyl groups contained in a single molecule of the long-chain polyol) may be, for example, in a range of 2 or more and 5 or less, or 2 or more and 3 or less.

In the long-chain polyol, the carbon chain having 6 or more carbon atoms is a chain in which a linear moiety of linking hydroxyl groups together has 6 or more carbon atoms. The carbon chain having 6 or more carbon atoms is, for example, an alkylene group, or a divalent group that is a combination of at least one alkylene group and at least one group selected from —O—, —C(═O)—, and —C(═O)—O—. The long-chain polyol in which hydroxyl groups are linked together via a carbon chain having 6 or more carbon atoms preferably has a structure of —[CO(CH₂)ₙ₁O]ₙ₂—H (where n1 represents 1 or more and 10 or less (preferably 3 or more and 6 or less, more preferably 5), n2 represents 1 or more and 50 or less (preferably 1 or more and 35 or less, more preferably 1 or more and 10 or less)).

Examples of the long-chain polyol include bifunctional polycaprolactonediols, trifunctional polycaprolactonetriols, and tetra- or higher functional polvcaprolactonepolyols,

Examples of the bifunctional polycaprolactonediols include a compound including two groups each represented by —[CO(CH₂)ₙ₁₁O]ₙ₁₂—H where n11 represents 1 or more and 10 or less (preferably 3 or more and 6 or less, more preferably 5), n12 represents 1 or more and 50 or less (preferably 4 or more and 35 or less), and including a hydroxyl group at the end. In particular, preferred is a compound represented by the following general formula (1).

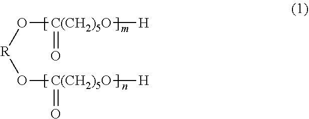

In the general formula (1), R represents an alkylene group, or a divalent group that is a combination of an alkylene group and at least one group selected from —O— and —C(═O)—; m and n each independently represent an integer of 1 or more and 35 or less,

In the general formula (1), the alkylene group included in the divalent group represented by R may be linear or branched. The alkylene group is, for example, preferably an alkylene group having 1 or more and 10 or less carbon atoms, more preferably an alkylene group having 1 or more and 5 or less carbon atoms.

The divalent group represented by R is preferably a linear or branched alkylene group having 1 or more and 10 or less carbon atoms (preferably 2 or more and 5 or less carbon atoms), preferably a group in which two linear or branched alkylene groups having 1 or more and 5 or less carbon atoms (preferably 1 or more and 3 or less carbon atoms) are coupled via —O— or —C(═O)— (preferably —O—). In particular, more preferred are divalent groups represented by *—C₂H₄—*, *—C₂H₄OC₂H₄—*, or *—C(CH₃)₂—(CH₂)₂—*. These divalent groups are bonded at the positions *.

m and n each independently represent an integer of 1 or more and 35 or less, preferably 2 or more and 10 or less.

Examples of the trifunctional polycaprolactonetriols include a compound including three groups each represented by —[CO (CH₂)ₙ₂₁O]ₙ₂₂—H (where n21 represents 1 or more and 10 or less (preferably 3 or more and 6 or less, more preferably 5), n22 represents 1 or more and 50 or less (preferably 1 or more and 28 or less)), and including a hydroxyl group at the end. In particular, preferred is a compound represented by the following general formula (2).

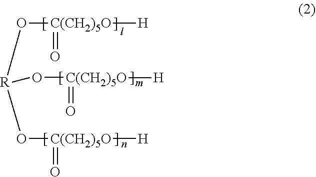

In the general formula (2), R represents a trivalent group that is provided by removing a hydrogen atom from an alkylene group, or a trivalent group that is a combination of a trivalent group provided by removing a hydrogen atom from an alkylene group, and at least one group selected from an alkylene group, —O—, and —C(═O)—. 1, m, and n each independently represent an integer of 1 or more and 28 or less, and 1+m+n satisfies 3 or more and 30 or less.

In the general formula (2), when R represents a trivalent group provided by removing a hydrogen atom from an alkylene group, the group may be linear or branched. For the trivalent group provided by removing a hydrogen atom from an alkylene group, the alkylene group is, for example, preferably an alkylene group having 1 or more and 10 or less carbon atoms, more preferably an alkylene group having 1 or more and 6 or less carbon atoms.

Alternatively, R may be a trivalent group that is a combination of a trivalent group provided by removing a hydrogen atom from the alkylene group, and at least one group selected from an alkylene group (for example, an alkylene group having 1 or more and 10 or less carbon atoms), —O—, and —C(═O)—.

The trivalent group represented by R is preferably a trivalent group provided by removing a hydrogen atom from a linear or branched alkylene group having 1 or more and 10 or less carbon atoms (preferably 3 or more and 6 or less carbon atoms). In particular, more preferred are trivalent groups represented by *—CH₂—CH(-*)-CH₂—*, CH₂—C(-*)(CH₂)₂—*, or CH₃CH₂C(-*) (-*) (CH₂)₃—*. These trivalent groups are bonded at the positions *

1, m, and n each independently represent an integer of 1 or more and 28 or less, preferably 2 or more and 10 or less. 1+m+n satisfies 3 or more and 30 or less, preferably 6 or more and 30 or less.

The long-chain polyol preferably has a hydroxyl value of 30 mgKOH/g or more and 300 mgKOH/g or less, more preferably 50 mgKOH/g or more and 250 mgKOH/g or less. When the hydroxyl value is 30 mgKOH/g or more, polymerization provides an acrylic-urethane resin having a high crosslink density. On the other hand, when the hydroxyl value is 300 mgKOH/g or less, an acrylic-urethane resin having appropriate flexibility tends to be provided.

The hydroxyl value is the number of milligrams of potassium hydroxide for achieving acetylation of hydroxyl groups in 1 g of the sample. In this exemplary embodiment, the hydroxyl value is measured in accordance with a method (potentiometric titration) defined in JIS K0070-1992. When the sample does not dissolve, a solvent such as dioxane or THF is used.

Ratio [OH_{A}/OH_{B}]

A ratio [OH_{A}/OH_{B}] of the hydroxyl value [OH_{A}] of the hydroxyl-group-containing acrylic resin (a) to the hydroxyl value [OH_{B}] of the long-chain polyol (b) is preferably 0.1 or more and 3 or less, more preferably 0.2 or more and 2.5 or less, still more preferably 0 3 or more and 2.0 or less.

When the ratio [OH_{A}/OH_{B}] is 0.1 or more, polymerization provides an acrylic-urethane resin having a high crosslink density. As a result, the resin particles added to a surface protective resin member tend to provide a surface protective resin member having high scratch resistance (such as self-healing properties). On the other hand, when the ratio [OH_{A}/OH_{B}] is 3 or less, an acrylic-urethane resin having appropriate flexibility tends to be obtained.

Multifunctional isocyanate (c)

The multifunctional isocyanate (c) is a compound having plural isocyanate groups (—NCO), and reacts with, for example, hydroxyl groups of the hydroxyl-group-containing acrylic resin (a) and hydroxyl groups of the long-chain polyol (b) to form urethane bonds (—NHCOO—). The multifunctional isocyanate (c) functions as a crosslinking agent that intermolecularly crosslinks the hydroxyl-group-containing acrylic resin (a), that crosslinks the hydroxyl-group-containing acrylic resin (a) and the long-chain polyol (b), and that intermolecularly crosslinks the long-chain polyol (b).

The multifunctional isocyanate is not particularly limited, and examples thereof include bifunctional diisocyanates such as methylene diisocyanate, toluene diisocyanate, hexamethylene diisocyanate, and isophorone diisocyanate. Other preferred examples include multifunctional isocyanates such as a polymer of hexamethylene polyisocyanate having a biuret structure, an isocyanurate structure, an adduct structure, or an elastic structure, for example.

The multifunctional isocyanate may be selected from commercially available products such as polyisocyanate (DURANATE) manufactured by Asahi Kasei Corporation.

Such multifunctional isocyanates may be used alone or in combination of two or more thereof.

The amount of multifunctional isocyanate is preferably adjusted such that the molar ratio f the isocyanate groups (—NCO) to the total amount of hydroxyl groups (—OH) in the hydroxyl-group-containing acrylic resin (a) and the long-chain polyol (b) is 0.8 or more and 1.5 or less, more preferably 1 or more and 1.3 or less.

When the amount of multifunctional isocyanate satisfies the molar ratio that is 0.8 or more, polymerization provides an acrylic-urethane resin having a high crosslink density. As a result, the resin particles added to a surface protective resin member tend to provide a surface protective resin member having high scratch resistance (such as self-healing properties). On the other hand, when the amount of multifunctional isocyanate satisfies the molar ratio that is 1.6 or less, an acrylic-urethane resin having appropriate elasticity tends to be obtained.

### Other Additives (e)

In this exemplary embodiment, the resin particles may contain other additives. Examples of the other additives include a coloring age an antistatic agent, and a reaction accelerator for accelerating the reaction of hydroxyl groups (—OH) of the hydroxyl-group-containing acrylic resin (a) and the long-chain polyol (b) and isocyanate groups (—NCO) of the multifunctional isocyanate (c)

### Coloring Agent

Examples of the coloring agent include various pigments such as carbon black, chrome yellow, Hansa yellow, benzidine yellow, threne yellow, quinoline yellow, pigment yellow, permanent orange GTR, pyrazolone orange, Vulcan orange, Watchung red, permanent red, brilliant carmine 3B, brilliant carmine GE, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and various dyes such as acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenylmethane dyes, diphenylmethane dyes, and thiazole dyes.

Such a coloring agent may be a coloring agent that is surface-treated, or may be used in combination with a dispersing agent. Plural coloring agents may be used in combination.

The coloring agent content relative to the total mass of the resin particles is preferably 14 mass % or more and 40 mass % or less, more preferably 2.0 mass % or more and 30 mass % or less.

### Antistatic Agent

Specific examples of the antistatic agent include cationic surfactants (such as tetraalkylammonium salts, trialkylbenzylammonium salts, hydrochloric acid salts of alkylamines, and imidazolium salts), anionic surfactants (such as alkylsulfonic acid salts, alkylbenzenesulfonic acid salts, and alkylphosphates), nonionic surfactants (such as glycerol fatty acid ester, polyoxyalkylene ether, polyoxyethylene alkyl enyl ether, N,N-bis-2-hydroxyethylalkylamine, hydroxyalkylmonoethanolamine, polyoxyethylenealkylamine, fatty acid diethanolamide, and polyoxyethylenealkylamine fatty acid ester), and amphoteric surfactants (such as alkylbetaine and alkylimidazolium betaine).

Other examples of the antistatic agent include quaternary ammonium-containing compounds.

Specific examples include tri-n-butylmethylammonium bistrifluoromethanesulfoneimide, lauryltrimethylammonium chloride, octyldimethylethylammonium ethylsulfate, didecyldimethylammonium chloride, lauryldimethylbenzylammonium chloride, stearyldimethylhydroxyethylammonium para-toluenesulfonate, tributylbenzylammonium chloride, lauryldimethylaminoacetic acid betaine, lauroylamide propylbetaine, octanamide propylbetaine, and polyoxyethylenestearylamine hydrochloric acid salts. Of these, preferred is tri-n-butylmethylammonium bistrifluoromethanesullfoneimide.

Other examples of the antistatic agent include high-molecular-weight antistatic agents.

Examples of the high-molecular-weight antistatic agents include polymers obtained by polymerizing quaternary ammonium base-containing acrylates, polystyrenesulfonic acid-based polymers, polycarboxylic acid-based polymers, polyetherester-based polymers, ethylene oxide-epichlorohydrin-based polymers, and polyetheresteramide-based polymers.

Examples of the polymers obtained by polymerizing quaternary ammonium base-containing acrylates include polymers at least including the following constitutional unit (A).

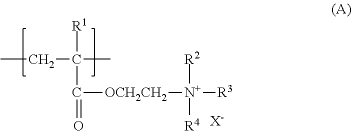

In the constitutional unit (A), R¹ represents a hydrogen atom or a methyl group; R², R³, and R⁴ each independently represent an alkyl group; and X represents an anion.

The high-molecular-weight antistatic agents can be polymerized by known methods.

Such a high-molecular-weight antistatic agent may be a single polymer species synthesized from the same polymerizable monomers, or may be a combination of two or more polymer species synthesized from different polymerizable monomers.

In this exemplary embodiment, the surface protective resin member is preferably formed so as to have a surface resistance in a range of 1×10⁹ Ω/□ or more and 1×10¹⁴ Ω/□ or less, and have a volume resistivity in a range of 1×10⁸ Ωcm or more and 1×10¹³ Ωcm or less.

The surface resistance and the volume resistivity are measured with HIRESTA UPMCP-450 equipped with a UR probe manufactured by DIA Instruments Co., Ltd., in an environment 22° C. and 55% RH, in accordance with JIS-K6911.

When such an antistatic agent is contained, for example, the type or content of the antistatic agent may be changed, to thereby control the surface resistance and the volume resistivity of the surface protective resin member.

The antistatic agents may be used alone or in combination of two or more thereof.

### Reaction Accelerator

A reaction accelerator may be added that accelerates the reaction of hydroxyl groups (—OH) of the hydroxyl-group-containing acrylic resin (a) and the long-chain polyol (b) and isocyanate groups (—NCO) of the multifunctional isocyanate (c). Examples of the reaction accelerator include metal catalysts such as tin octanoate, dibutyltin diacetate, dibutyltin dilaurate, bismuth octanoate, and bismuth decanoate, for example, NEOSTANN U-28, U-50, and U-600 manufactured by Nitto Kasei Co., Ltd.

### Method for Producing Resin Particles

A method for producing resin particles including an acrylic-urethane resin as the main component and having a Martens hardness, a recovery ratio, and a volume average particle size D50v that satisfy the above-described ranges according to this exemplary embodiment will be described in detail.

The method for producing the resin particles according to this exemplary embodiment is not limited as long as the resin particles have the above-described features. However, from the viewpoint of easily producing resin particles that satisfy the above-described features, the resin particles are preferably produced by, for example, a wet production method such as a dissolution-suspension process.

### Dissolution-Suspension Process

The dissolution-suspension process of producing resin particles according to this exemplary embodiment is, for example, a process that includes an oil-phase preparation step of dissolving or dispersing, in an organic solvent, at least polymerizable components (such as the above-described hydroxyl-group-containing acrylic resin (a), long-chain polyol (b), and multifunctional isocyanate (c)) to prepare an oil phase, a particle-formation step of suspending the oil-phase component in an aqueous phase to form particles, and a solvent removal step of removing the solvent.

### Oil-Phase Preparation Step

In the dissolution-suspension process, polymerizable components (such as the above-described hydroxyl-group-containing acrylic resin (a), long-chain polyol (b), and multifunctional isocyanate (c)) are dissolved or dispersed in an organic solvent to prepare an oil phase.

The organic solvent employed depends on the types of the polymerizable components. In general, examples of the organic solvent include hydrocarbons such as toluene, xylene, and hexane; halogenated hydrocarbons such as methylene chloride, chloroform, and dichloroethane; alcohols and ethers such as ethanol, butanol, benzyl alcohol ether, and tetrahydrofuran; esters such as methyl acetate, ethyl acetate, butyl acetate, and isopropyl acetate; and ketones such as acetone, methyl ethyl ketone, diisobutyl ketone, cyclohexanone, and methylcyclohexane. The mass ratio of the polymerizable components to the solvent in the oil phase is preferably in a range of 10:90 to 80:20 from the viewpoint of easiness of formation of particles or the final yield of the resin particles.

In this exemplary embodiment, when an additive such as a coloring agent is added to the resin particles, prior preparation of the oil phase, the additive is preferably dispersed with a synergist and a dispersing agent to prepare an additive dispersion liquid, and the additive dispersion liquid is preferably mixed with polymerizable components (such as the above-described components (a), (b), and (c)). The preparation of the additive dispersion liquid is performed in the following manner. The synergist and the dispersing agent are made to adhere to the additive. This adhesion to the additive is achieved with a standard stirring device. Specifically, for example, into a container including particulate media such as an attritor, a ball mill, a sand mill, or a vibration mill, the additive, the synergist, and the dispersing agent are charged, and stirred in the container kept in a preferred temperature range such as from 20° C. to 160° C.

### Particle-Formation Step

Subsequently, these oil-phase components are suspended in an aqueous phase so as to be formed into particles having the target particle size. The main medium of the aqueous phase is water, and the water is preferably mixed with a dispersing agent. The water may be mixed with common salt and used as a saline solution.

The dispersing agent forms hydrophilic colloid to thereby achieve stable dispersion of oil phase droplets. Examples of inorganic dispersing agents include calcium carbonate, magnesium carbonate, barium carbonate, tricalcium phosphate, hydroxyapatite, silica/diatomaceous earth, and clay.

Such an inorganic dispersing agent may be used in combination with an organic dispersing agent. Specific examples of the organic dispersing agent include proteins such as gelatin, gelatin derivatives (such as acetylated gelatin, phthalated gelatin, and succinated gelatin), albumin, and casein; collodion, gum arabic, agar, alginic acid, cellulose derivatives (such as alkyl esters of carboxymethylcellulose, hydroxymethylcellulose, and carboxymethylcellulose), and synthetic polymers (such as polyvinyl alcohol, polyvinylpyrrolidone, polyacrylamide, polyacrylate, polymethacrylate, polymaleate, and polystyrenesulfonate).

Such dispersing agents may be used alone or in combination of two or more thereof.

The amount of dispersing agent used relative to the main medium of the aqueous phase is preferably in a range of 0.001 mass % or more and 5 mass % or less.

The aqueous phase may further contain a dispersing auxiliary agent. The dispersing auxiliary agent is preferably a surfactant. Examples of the surfactant include ionic and nonionic surfactants. Such dispersing auxiliary agents may be used alone or in combination of two or more thereof. The amount of dispersing auxiliary agent used relative to the main medium of the aqueous phase is preferably in a range of 0.001 mass % or more and 5 mass % or less.

The mixing ratio of the oil phase to the aqueous phase varies depending on the target particle size of resin particles and the production apparatuses. However, the mass ratio of oil phase/aqueous phase is preferably in a range of 10/90 to 90/10. The formation of particles of the oil phase within the aqueous phase is preferably performed under high-rate shearing. The smaller the target particle size of the resin particles, the more carefully the dispersing device having a high-rate shearing mechanism is desirably selected. In particular, preferred are emulsification-dispersing devices of rotating impellers at high rates or forcing the fluid to pass through openings, such as various homomixers, homogenizers, colloid mills, ULTRA-TURRAX, and CLEARMILL.

### Solvent Removal Step

During the particle-formation step or after the particle-formation step, the solvent (organic solvent) is removed. The solvent may be removed at room temperature (such as 25° C.) and optionally under a reduced pressure. In order to perform the removal at room temperature, the temperature is desirably set to a value that is lower than the boiling point of the solvent and that is selected in consideration of the glass transition temperature Tg of the resin (acrylic-urethane resin). When the temperature is set to a value much higher than Tg of the resin, resin particles may coalesce.

Specifically, the solvent removal step may be performed in the following manner, though the conditions vary depending on the amount of reaction accelerator added. For example, the solvent is removed by stirring at 40° C. for 1 hour or more and 3 hours or less, and by subsequent stirring at 60° C. for 2 hours or more and 6 hours or less to cause a crosslinking reaction, to thereby achieve formation of particles. When the step is performed under a reduced pressure, the pressure is preferably set to 20 mmHg to 150 mmHg

The resultant particle-containing substance (slurry substance) is preferably, after the removal of the solvent, washed with an acid that makes the inorganic dispersing agent be water-soluble, such as hydrochloric acid, nitric acid, formic acid, or acetic acid. As a result, the inorganic dispersing agent remaining on the surfaces of the resin particles is removed. The particle-containing substance having been treated with the acid may be further washed with aqueous alkali of sodium hydroxide, for example. In this way, some ionic substances that are on the surfaces of the resin particles and become insoluble due to the oxidizing atmosphere, are made soluble again and removed, so that the electrification properties and powder fluidity are improved. Preferably, the washing is effectively performed by adjusting washing conditions such as pH during washing, the number of washing processes, and the temperature during washing, and by using, for example, a stirrer or an ultrasonic dispersing device. Subsequently, additional steps such as filtration, decantation, or centrifugation may be performed. The resultant substance is dried to provide resin particles.

The drying may be performed by a process selected from standard drying processes. Examples of the processes include a process using a flash dryer, such as a drying treatment using a flash jet dryer, and a treatment using a fluid bed. Alternatively, a freeze-drying process may be employed. In particular, when the resin particles contain no fluorine atoms, the resin particles tend to aggregate in the drying step, and hence the freeze-drying process is preferably used.

### Surface Protective Resin Member

### First Exemplary Embodiment

A surface protective resin member according to a first exemplary embodiment includes a resin and resin particles according to the above-described exemplary embodiment dispersed in the resin.

Thus, the surface protective resin member has a structure in which the resin particles according to the exemplary embodiment are dispersed in the continuous phase of the resin.

This structure provides a surface protective resin member having high scratch resistance (such as self-healing properties).

### Second Exemplary Embodiment

In this exemplary embodiment, the surface protective resin member is not limited to the surface protective resin member according to the first exemplary embodiment.

Specifically, the surface protective resin member according to the second exemplary embodiment includes a resin and resin particles dispersed in the resin, having a volume average particle size D50v of 3 μm or more and 50 μm or less, and added in an amount of 5 vol % or more and 50 vol % or less relative to the entirety of the surface protective resin member, wherein the surface protective resin member has a Martens hardness at 23° C. of 0.5 N/mm² or more and 220 N/mm² or less, and a recovery ratio at 23° C. of 70% or more and 100% or less.

The surface protective resin member according to the second exemplary embodiment has such features, to thereby exhibit good self-healing properties in spite of the presence of interfaces between the resin particles and the resin forming the continuous phase.

The surface protective resin member according to the second exemplary embodiment may be provided by using, as the resin particles, for example, the resin particles (for addition to a surface protective resin member) according to the above-described exemplary embodiment. However, this is no limiting.

### Martens Hardness of Surface Protective Resin Member

In the surface protective resin member according to the second exemplary embodiment, the Martens hardness at 23° C. is 0.5 N/mm² or more and 220 N/mm² or less, preferably 1 N/mm² or more and 80 N/mm² or less, more preferably 1 N/mm² or more and 5 N/mm² or less.

When the Martens hardness (23° C.) is 220 N/mm² or less, good self-healing properties are provided. On the other hand, when the Martens hardness (23° C.) is 0.5 N/mm² or more, the surface protective resin member tends to maintain the designed shape.

Incidentally, the surface protective resin member according to the first exemplary embodiment also preferably has a Martens hardness at 23° C. satisfying such a range.

### Recovery Ratio of Surface Protective Resin Member

In the surface protective resin member according to the second exemplary embodiment, the recovery ratio at 23° C. is 70% or more and 100% or less, preferably 80% or more and 100% or less, more preferably 90% or more and 100% or less.

The recovery ratio an index of self-healing properties (properties of recovering from strain (caused by application of a stress) within 1 min after removal of the stress, namely, the degree of healing scratches) of the surface protective resin member. When the recovery ratio (23° C.) is 70% or more, the probability of healing scratches (namely, self-healing properties) is improved.

Incidentally, the surface protective resin member according to the first exemplary embodiment also preferably has a recovery ratio at 23° C. satisfying such a range,

The Martens hardness and recovery ratio of the surface protective resin member are measured with an instrument, FISCHERSCOPE HM2000 (manufactured by Fischer). A sample (surface protective resin member) is fixed on a slide glass with an adhesive, and mounted on the instrument. To the sample, a load is applied and increased to 0.5 mN over period of 15 seconds at a predetermined measurement temperature (for example, 23° C.), and the load of 0.5 mN is maintained for 5 seconds. In this process, the maximum displacement is measured as h1. Subsequently, the load is decreased to 0.005 mN over a period of 15 seconds, and the load of 0.005 mN is maintained for 1 minute during which the displacement is measured as h2. From h1 and h2, the recovery ratio is calculated using [(h1−2)/h1]×100(%). In this measurement, a load-displacement curve is created, and this curve is used to determine Martens hardness.

### Surface Roughness Ra of Surface Protective Resin Member

In the surface protective resin member according to the first exemplary embodiment or second exemplary embodiment, the surface roughness Ra is preferably 0.2 μm or more and 10 μm or less, more preferably 0.3 μm or more and 8 μm or less, still more preferably 0.4 μm or more and 5 μm or less.

When the surface roughness Ra is 0.2 μm or more, the surface has reduced glossiness, which tends to improve the matting effect. On the other hand, when the surface roughness Ra is 10 μm or less, the effect of suppressing degradation of scratch resistance tends to be provided.

The surface roughness Ra of the surface protective resin member is controlled by adjusting, for example, the particle size or amount of resin particles added.

The surface roughness Ra (center-line-average roughness) of the surface protective resin member is measured in accordance with JIS B0601 (1994). Specifically, three points on the surface of the surface protective resin member are randomly selected and measured, and the measured values are averaged to obtain the surface roughness Ra. The measurement device is SURF COM 1400 manufactured by TOKYO SEIMITSU CO., LTD. The measurement conditions are a cutoff of 0.8 mm, a measurement length of 2.4 mm, and a traverse speed of 0.3 mm/sec.

### Average Thickness of Surface Protective Resin Member

In the surface protective resin member according to the first exemplary embodiment or the second exemplary embodiment, the average thickness is preferably 5 μm or more and 100 μm or less, more preferably 10 μm or more and 80 μm or less, still more preferably 20 μm or more and 60 μm or less.

When the average thickness is 5 μm or more, high scratch resistance (such as self-healing properties) tends to be provided. On the other hand, when the average thickness is 100 μm or less, the ease of formation of the surface protective resin member tends to be improved.

The average thickness of the surface protective resin member may be measured with a known device and by a known method. For example, when the substrate is plate-shaped or sheet-shaped, the substrate and the surface protective resin member formed thereon are collectively measured at 10 points randomly selected; from each of the measured values, the thickness of the substrate is subtracted, and the resultant values are averaged to determine the average thickness of the surface protective resin member. The measurement device is selected from standard micrometers such as a micrometer (model: MDH-25MB) manufactured by Nitutoyo Corporation.

### Amount of Resin Particles Added to Surface Protective Resin Member

In the surface protective resin member according to the second exemplary embodiment, the amount of the resin particles added is 5 vol % or more and 50 vol % or less, preferably 6 vol % or more and 40 vol % or less, more preferably 8 vol % or more and 30 vol % or less.

When the amount of the resin particles added is 5 vol % or more, the surface has reduced glossiness, which tends to improve the matting effect. On the other hand, when the amount of the resin particles added is 50 vol % or less, high scratch resistance (such as self-healing properties) tends to be provided.

Incidentally, in the surface protective resin member according to the first exemplary embodiment, the amount of the resin particles added also preferably satisfies such a range.

### Composition of Continuous Phase (Resin) in Surface Protective Resin Member

In the surface protective resin member according to the first exemplary embodiment or the second exemplary embodiment, the resin forming the continuous phase is preferably a resin having scratch resistance (such as healing properties).

The resin having scratch resistance (such as self-healing properties) and forming the continuous phase is not particularly limited and may be selected from known resins. However, when the resin particles added are the above-described resin particles according to the exemplary embodiment, the resin is preferably an acrylic-urethane resin from the viewpoint of compatibility with the resin particles

The acrylic-urethane resin forming the continuous phase may be obtained by, for example, a reaction of an acrylic resin having hydroxyl groups in the molecular structure (specifically the above-described hydroxyl-group-containing acrylic resin (a)), and an isocyanate having plural isocyanate groups (specifically the above-described multifunctional isocyanate (c)).

From the viewpoint of obtaining a surface protective resin member having high scratch resistance (such as self-healing properties), the resin forming the continuous phase is also preferably, as described in the section “Resin particles” in the exemplary embodiment, a reaction product of the hydroxyl-group-containing acrylic resin (a), the polyol. (long-chain polyol) (b) containing plural hydroxyl groups linked together via a carbon chain having 6 or more carbon atoms, and the multifunctional isocyanate (c).

The acrylic-urethane resin that is the resin forming the continuous phase is more preferably, from the viewpoint of scratch resistance (such as self-healing properties), a reaction product of a polymerizable component group in which the above-described components (a), (b), and (c) in total account for 90 mass % or more of all the polymerizable components.

When the resin forming the continuous phase and the resin that is the main component of the resin particles are both acrylic-urethane resins, from the viewpoint of suppression of repelling of the resin particles by the continuous phase to achieve improved dispersion, only one of the acrylic-urethane resin that forms the continuous phase and the acrylic-urethane resin that is the main component of the resin particles preferably contains fluorine atoms (for example, preferably a reaction product using, as a polymerizable component, the hydroxyl-group-containing acrylic resin (a) including fluorine atoms).

Furthermore, from the viewpoint of improving formability of the particulate shape of resin particles, the acrylic-urethane resin that forms the continuous phase is preferably a resin not containing fluorine atoms, while the acrylic-urethane resin that is the main component of the resin particles contains fluorine atoms (for example, a reaction product using, as a polymerizable component, the hydroxyl-group-containing acrylic resin (a) containing fluorine atoms).

The surface protective resin member according to the first exemplary embodiment or the second exemplary embodiment can be produced, for example, in the following manner.

For example, the hydroxyl-group-containing acrylic resin (a), the long-chain polyol (b), the multifunctional isocyanate), and resin particles (for example, the above-described resin particles according to the exemplary embodiment) are mixed together, defoamed under a reduced pressure, and then cast onto a substrate (such as a polyimide film, an aluminum plate, or a glass plate) to form a resin layer. The resin layer is then cured by heating (for example, at 85° C. for 60 minutes, subsequently at 130° C. for 0.5 hours), to thereby form a surface protective resin member.

However, in this exemplary embodiment, the method for forming the surface protective resin member is not limited to the above-described method. For example, when a blocked multifunctional isocyanate is used, heating is preferably performed at a deblocking temperature or higher to achieve curing. Instead of the defoaming under a reduced pressure, defoaming may be achieved by, for example, using ultrasonic waves or leaving the mixed solution to stand.

### Applications

The surface protective resin members according to the exemplary embodiments (the first exemplary embodiment and the second exemplary embodiment) are applicable, as surface protective members, to, for example, articles that may become scratched during contacts with other objects. In particular, the surface protective resin members are suitably used, for example, in applications in which surfaces are designed to have reduced glossiness (for example, matte surfaces).

Specific examples of applications in which surfaces are designed to have reduced glossiness include interior materials (such as wall materials as building materials and automotive interiors), furniture (such as sofas), seat products (such as bags and satchels), floor materials, and tiles.

Other examples of applications include screens and other bodies in portable devices (such as cellular phones and portable gaming devices); screens of touch panels; building materials; automotive members (such as automotive bodies and automotive door handles); containers (such as suitcases); containers of cosmetics; glasses (such as frames and lenses); sports goods (such as golf clubs and rackets); writing materials (such as fountain pens) ; musical instruments (such as the exteriors of pianos); tools for storing clothing (such as hangers); and members of image forming apparatuses such as copy machines (such as transfer members, for example, transfer belts).

### EXAMPLES

Hereinafter, the present disclosure will be described further in detail with reference to Examples and Comparative Examples. However, the present disclosure is not limited to the following Examples. Incidentally, “part” and “parts” in the following description are based on mass unless otherwise specified.

### Example 1

### Preparation of Resin Particles

### Synthesis of Acrylic Resin Prepolymer A1

Polymerizable monomers that are n-butyl methacrylate (nBMA), hydroxyethyl methacrylate (HEMA), and an acrylic monomer containing a fluorine atom and a vinyl group (FAMAC6, manufactured by UNIMATEC CO., LTD.) are mixed in a molar ratio of 2.5:3:0.5. In addition, a polymerization initiator (azobisisobutyronitrile (AIBN)) is added in an amount of 2 mass % relative to the polymerizable monomers; methyl ethyl ketone (MEK) is added in an amount of 40 mass % relative to the polymerizable monomers to prepare a polymerizable monomer solution

The polymerizable monomer solution is charged into a dropping funnel, and drooped over a period of 3 hours in a nitrogen atmosphere under reflux, into MEK that is stirred, that is heated at 8020 C., and that has an amount of 50 mass % relative to the polymerizable monomers, to thereby cause polymerization. Subsequently, a solution composed of MEK in an amount of 10 mass % relative to the polymerizable monomers and AIBN in an amount of 05 mass relative to the polymerizable monomers is dropped over a period of 1 hour, to complete the reaction. During the reaction, the reaction solution is kept at 80° C. and continuously stirred. Thus, an acrylic resin prepolymer A1 is synthesized.

The obtained acrylic resin prepolymer A1 is measured for hydroxyl value in accordance with a method (potentiometric titration.) defined in JIS X0070-1992. The hydroxyl value is found to be 175 mgKOH/g.

The acrylic resin prepolymer A1 is measured for weight-average molecular weight by the above-described method using gel permeation chromatography (GPC). The weight-average molecular weight is found to be 19000.

Preparation of Resin Particles A1 using Dissolution-Suspension Process

### Polymerizable Component Solution

The following components are mixed and defoamed under a reduced pressure for 10 minutes, to obtain a polymerizable component solution.

Acrylic resin prepolymer A1 solution (solid content; 50 mass %) : 4.4 parts

Long-chain polyol (polycaprolactonetriol, PLACCEL 308, manufactured by Daicel Corporation, molecular weight: 850, hydroxyl value: 190 to 200 mgKOH/g): 5.2 parts

Multifunctional isocyanate (DURANATE TPA100, manufactured by Asahi Kasei Chemicals Corporation, compound name: polyisocyanurate of hexarnethylene diisocyanate): 6.4 parts

Crosslinking catalyst (NEOSTANN U-600, manufactured by Nitto Kasei Co., Ltd., compound name: dibutyl-tin): 0.08 parts

Methyl ethyl ketone: 12 parts

The fluorine atom content of the polymerizable component solution relative to the entire solid content is 2,0 mass %. The fluorine atom content relative to the entirety of the finally obtained resin particles A1 is also 2.0 mass %.

The ratio [OH_{A}/OH_{B}] of the hydroxyl value [OH_{A}] (175 mgKOH/g) of the acrylic resin prepolymer A1 to the hydroxyl value [OH_{B}] (190 to 200 mgKOH/g) of the long-chain polyol is 0.92 to 0.875

### Calcium Carbonate Dispersion Liquid

Calcium carbonate (LUMINUS, manufactured by MARUO CALCIUM CO., LTD.): 36 parts

Anionic surfactant (NEOGEN RK, manufactured by DAI-ICHI KOGYO SEIYAKU CO., LTD.): 1.0 part

Common salt (NaCl): 90 parts

Ion-exchanged water: 420 parts

The above-described components are mixed and dispersed using zirconia balls in a ball mill for 24 hours.

### Preparation of Resin Particles

To 135 parts of the calcium carbonate dispersion liquid, 100 parts of the polymerizable component solution is added under operation of a homogenizer (manufactured by IKA-WERKE GMBH & CO. KG, ULTRA-TURRAX T50) to achieve uniform emulsification. Subsequently, the organic solvent (MEK) is removed for 2 hours while the emulsion is heated at 40° C.; subsequently, the emulsion is heated at 60° C. for 3 hours. Subsequently, 300 parts of 1 N hydrochloric acid is added, to dissolve a large portion of the calcium carbonate. The resultant solution is passed through a 15 micron nylon mesh, subsequently filtered, sufficiently rinsed with ion-exchanged water, and subjected to Nutsche suction filtration to achieve solid-liquid separation. The resultant solid is dispersed again in ion-exchanged water at 40° C., and rinsed under stirring for 15 minutes with a stainless steel impeller rotated at 100 rpm. This rinsing procedure is repeated three times, subjected to Nutsche suction filtration to achieve solid-liquid separation. The resultant solid is adjusted to have a water content of 40%, and subsequently dried with flash jet dryer with an inlet jet temperature set at 60° C., to obtain resin particles A1.

### Properties of Resin Particles

The particle size of resin particles A1 is measured. As a result, the volume-average particle size D50v is found to be 12 μm, and the volume-based particle-size-distribution index GSDv is found to be i 3. The average circularity is found to be 0.95.

The same components as in the resin particles A1 are used to form a resin film (average thickness: 30 μm). This resin film used as a sample, and measured for Martens hardness (23° C.) and recovery ratio (23° C.). As a result, the Martens hardness is found to be 3.5 N/mm², and the recovery ratio is found to be 86%.

### Formation of Resin Film

### Synthesis of Acrylic Resin Prepolymer B1

Polymerizable monomers that are n-butyl methacrylate (nEMA) and hydroxyethyl methacrylate (HEMA) are mixed in a molar ratio of 3:3, In addition, a polymerization initiator (azobisisobutyronitrile (AIBN)) is added in an amount of 2 mass % relative to the polymerizable monomers, and methyl ethyl ketone (MEK) is added in an amount of 40 mass % relative to the polymerizable monomers, to prepare a polymerizable monomer solution.

This polymerizable monomer solution is charged into a dropping funnel, and dropped over a period of 3 hours, in a nitrogen atmosphere under reflux, into MEK that is stirred, that is heated at 80° C., and that has an amount of 50 mass % relative the polymerizable monomers, to achieve polymerization. Subsequently, a solution composed of MEK having an amount of 10 mass % relative to the polymerizable monomers and AIBN having an amount of 0.5 mass % relative to the polymerizable monomers is dropped over a period of 1 hour, to complete the reaction. During the reaction, the reaction solution is set at 80° C. and continuously stirred. Thus, an acrylic resin prepolymer B1 is synthesized.

The acrylic resin prepolymer B1 is found to have a hydroxyl value of 206 mgKOH/g.

The acrylic resin prepolymer B1 is found to have a weight-average molecular weight of 17100.

The acrylic resin prepolymer B1 does not contain fluorine atoms.

### Formation of Resin Film B1

The following components are mixed, and defoamed for 10 minutes under a reduced pressure. The mixture is applied to a black PET film having a thickness of 125 μm (LUMIRROR X30 manufactured by Toray Industries, Inc.) with a bar coater, and cured at 80° C. for 2 hours, to obtain a resin film

Acrylic resin prepolymer B1 solution (solid content: 50 mass % ): 4.0 parts

Long-chain polyol (polycaprolactonetriol, PLACCEL 308, manufactured by Daicel Corporation, molecular weight: 850, hydroxyl value: 190 to 200 mgKOH/g): 3.6 parts

Multifunctional isocyanate (DURANATE TPA100, manufactured by Asahi Kasei Chemicals Corporation, compound name: polyisocyanurate of hexamethylene diisocyanate): 3.6 parts

Crosslinking catalyst (NEOSTANN U-600, manufactured by Nitto Kasei Co., Ltd., compound name: dibutyl-tin): 0.02 parts

Resin particles A1: 2.3 parts

Methyl ethyl ketone: 7.5 parts

The ratio [OH_{A}/OH_{B}] of the hydroxyl value [OH_{A}] (206 mgKOH/g) of the acrylic resin prepolymer B1 to the hydroxyl value [OH_{B}] (190 to 200 mgKOH/g) of the long-chain polyol is 1.03 to 1.08.

### Properties of Resin Film

In the resin film B1, the amount of resin particles A1 added is 20 vol %.

The resin film B1 is found to have a surface roughness Ra of 2.2 μm, and an average thickness of 30 μm.

The resin film B1 is measured for Martens hardness (23° C.) and recovery ratio (23° C.). The Martens hardness is found to be 3.4 N/mm², and the recovery ratio is found to be 87%.

### Examples 2 to 7

In Examples 2 to 7, resin films are formed as in Example 1 except for the following differences. The properties and evaluation results are described in Table 1 below.

In Example 2, the amount of the long-chain polyol in the preparation of resin particles A1 in Example 1 is changed from 5.2 parts to 0.4 parts.

In Example 3, in the preparation of resin particles A1 in Example 1, the amount of acrylic resin prepolymer A1 solution (solid content: 50 mass %) is changed from 4.4 parts to 1.0 part, and the amount of long-chain polyol is changed from 5.2 parts to 8.6 parts.

In Example 4, the amount of long-chain polyol in the preparation of resin particles A1 in Example 1 is changed from 5.2 parts to 2.6 parts.

In Example 5, in the formation of resin film B1 in Example 1, the amount of long-chain polyol is changed from 3.6 parts to 0.36 parts.

In Example 6, in the formation of resin film B1 in Example 1, the amount of acrylic resin prepolymer B1 solution (solid content: 50 mass %) is changed from 4.0 parts to 1.0 part, and the amount of long-chain polyol is changed from 3.6 parts to 5.1 parts.

In Example 7, in the formation of resin film B1 in Example 1, the amount of long-chain polyol changed from 3.6 parts to 1.8 parts.

### Comparative Examples 1 to 3

In Comparative Examples 1 to 3, resin films are formed as in Example 1 except for the following differences. Properties and evaluation results are described in Table below.

In Comparative Example 1, in the synthesis of acrylic resin prepolymer A1 and the synthesis of acrylic resin prepolymer B1 in Example 1, n-butyl methacrylate (nEMA) is changed to methyl methacrylate; in the preparation of resin particles A1, the amount of long-chain polyol is changed from 5.2 parts to 0.4 parts; in the formation of resin film B1, the amount of long-chain polyol is changed from 3.6 parts to 0.36 par in the formation resin film B1l, the amount of acrylic resin prepolymer B1 solution (solid content: 50 mass %) is changed from 4.0 parts to 1.0 part; and, in the preparation of resin particles A1 and the formation of resin film B1, the multifunctional isocyanate (DURANATE TPA100) is changed to a bifunctional isocyanate (DURANATE D101).

In Comparative Example 2, the preparation of resin particles A1 in Example 1, the amount of acrylic resin prepolymer A1 solution (solid content: 50 mass %) is changed from 4.4 parts to 0.4 parts.

In Comparative Example 3, in the preparation of resin particles A1 in Example 1, the amount of long-chain polyol is changed from 5.2 parts to 0.0 parts (no addition); and, in the preparation of resin particles A1 and in the formation of resin film B1, the multifunctional isocyanate (DURANATE TPA100) is changed to a bifunctional isocyanate (DURANATE D101).

### Evaluation Tests

### Evaluation of Matting

The resin films obtained in Examples and Comparative Examples are evaluated for matting in the following manner. The results are described in Table 1.

The resin films are measured with a micro-TRI-gloss meter manufactured by Gardner, for 20° gloss.

### Evaluation System

A: gloss value of less than 50

B: gloss value of 50 or more and less than 60

C: gloss value of 60 or more and less than 80

D: gloss value of 80 or more

### Evaluation of Scratch Resistance

The resin films obtained in Examples and Comparative Examples are evaluated for scratch resistance in the following manner. The results are described in Table 1.

Each resin film is rubbed with a brass brash having a wire diameter of 0.15 mm, and a wire length of 16 mm, and the degree of healing the scratches is visually inspected.

### Evaluation System

A: the scratches disappear instantly

B: the scratches disappear within 1 minute

C: the scratches disappear in a period of more than 1 minute and 60 minutes or less

D: the scratches do not disappear even after the lapse of 60 minutes

Grades A and B are acceptable levels of scratch resistance.

TABLE 1

| | | Resin particles | | | | | | Resin film | | | | | | |
|---|---|---|---|---|---|---|---|---|---|---|---|---|---|---|
| | | | | Volume | Volume | | | Amount | | | Surface | | | |
| | | Martens | | average | based | | | of resin | Martens | | rough- | | Evaluation | |
| | | hard- | Recovery | particle | particle size | Average | Ratio | particles | hard- | Recovery | ness | Average | | Scratch |
| | | ness | ratio | size | distribution | circu- | OH_{A}/ | added | ness | ratio | Ra | thickness | Mat- | resis- |
| | | N/mm² | % | μm | index GSDv | larity | OH_{B} | vol % | N/mm² | % | μm | μm | ting | tance |
| Example | 1 | 3.5 | 86 | 12 | 1.3 | 0.95 | 0.9 | 20 | 3.4 | 87 | 2.2 | 30 | A | A |
| | 2 | 210 | 70 | 12 | 1.3 | 0.92 | 0.9 | 20 | 4.2 | 82 | 2.4 | 30 | A | B |
| | 3 | 0.5 | 92 | 14 | 1.4 | 0.86 | 0.9 | 20 | 2.9 | 90 | 2.8 | 30 | A | B |
| | 4 | 200 | 75 | 12 | 1.3 | 0.92 | 0.9 | 20 | 3.8 | 80 | 2.6 | 30 | A | B |
| | 5 | 3.5 | 86 | 12 | 1.3 | 0.95 | 0.9 | 20 | 218 | 70 | 2.6 | 35 | A | B |
| | 6 | 3.5 | 86 | 12 | 1.3 | 0.95 | 0.9 | 20 | 0.6 | 90 | 2.8 | 35 | B | B |
| | 7 | 3.5 | 86 | 12 | 1.3 | 0.95 | 0.9 | 20 | 206 | 72 | 3.4 | 38 | A | B |
| Compar- | 1 | 225 | 68 | 10 | 1.4 | 0.9 | 1 | 20 | 230 | 66 | 1.4 | 30 | B | D |
| ative | 2 | 0.4 | 65 | 9 | 1.5 | 0.86 | 0.9 | 20 | 0.4 | 60 | 1 | 30 | B | D |
| Example | 3 | 250 | 60 | 12 | 1.4 | 0.9 | ∞ | 20 | 250 | 65 | 3.2 | 30 | A | D |

As described in Table 1, in Examples, resin particles containing an acrylic-urethane resin as the main component, having a Martens hardness at 23° C. of 0.5 N/mm² or more and 220 N/mm² or less, a recovery ratio at 23° C. of 70% or more and 100% or less, and a volume average particle size D50v of 3 μm or more and 50 μm or less are added in an amount of 5 vol % or more and 50 vol % or less relative to the entirety of each resin film to form the resin film. The resin film has a Martens hardness at 23° C. of 0.5 N/mm² or more and 220 N/mm² or less, and a recovery ratio at 23° C. of 70% or more and 100% or less. These Examples have demonstrated that high scratch resistance is achieved, compared with Comparative Examples in which resin particles have Martens hardnesses higher than the upper limit and resin films also have Martens hardnesses higher than the upper limit, and Comparative Examples in which resin particles have recovery ratios lower than the lower limit and resin films also have recovery ratios lower than the lower limit.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated, it is intended that the scope of the disclosure be defined by the following claims and their equivalents

What is claimed is:

1. Resin particles for addition to a surface protective resin member, the resin particles comprising an acrylic-urethane resin as a main component,
the resin particles having a martens hardness at 23° C. in a range of 0.5 N/mm² to 220 N/mm², a recovery ratio at 23° C. in a range of 70% to 100%, and a volume average particle size D50v in a range of 3 μm to 50 μm.

2. The resin particles according to claim 1, wherein the resin particles have a volume-based particle size distribution index GSDv in a range of 1.0 to 1.5 calculated using (D84v/D16v)^{1/2}.

3. The resin particles according to claim 1, wherein the resin particles have an average circularity in a range of 0.8 to 1.0.

4. The resin particles according to claim 1, wherein the acrylic-urethane resin is a reaction product of a hydroxyl-group-containing acrylic resin (a), a polyol (b) having a plurality of hydroxyl groups linked together via a carbon chain having 6 or more carbon atoms, and multifunctional isocyanate (c).

5. The resin particles according to claim 4, wherein a ratio [OH_{A}/OH_{B}] of a hydroxyl value [OH_{A}] of the hydroxyl-group-containing acrylic resin (a) to a hydroxyl value [OH_{B}] of the polyol (b) is in a range of 0.1 to 3.

6. The resin particles according to claim 4, wherein the hydroxyl-group-containing acrylic resin (a) is an acrylic resin in which a molar content ratio of hydroxyl groups of hydroxyl-group-containing side chains each having 10 or more carbon atoms to hydroxyl groups of hydroxyl-group-containing side chains each having less than 10 carbon atoms is less than 1/3, or
an acrylic resin in which all hydroxyl-group-containing side chains each have less than 10 carbon atoms.

7. The resin particles according to claim 4, wherein the hydroxyl-group-containing acrylic resin (a) is an acrylic resin containing fluorine atoms.

8. The resin particles according to claim 1, further comprising a coloring agent.

9. A surface protective resin member comprising:
a resin; and
the resin particles according to claim 1 being dispersed in the resin.

10. The surface protective resin member according to claim 9, wherein the surface protective resin member has a Martens hardness at 23° C. in a range of 0.5 N/mm² to 220 N/mm², and a recovery ratio at 23° C. in a range of 70% to 100%.

11. The surface protective resin member according to claim 9, wherein surface protective resin member has a surface roughness Ra in a range of 0.2 μm to 10 μm.

12. The surface protective resin member according to claim 9, wherein the surface protective resin member is a resin film having an average thickness in a range of 5 μm to 100 μm.

13. The surface protective resin member according to claim 9, wherein an amount of the resin particles added relative to an entirety of the surface protective resin member is in a range of 5 vol % to 50 vol %.

14. A surface protective resin member comprising:
a resin; and
resin particles dispersed in the resin, having a volume average particle size D50v in a range of 3 μm to 50 μm, and added in an amount, relative to an entirety of the surface protective resin member, in a range of 5 vol % to 50 vol %,
the surface protective resin member having a Martens hardness at 23° C. in a range of 0.5 N/mm² to 220 N/mm², and a recovery ratio at 23° C. in a range of 70% to 100%.

15. The surface protective resin member according to claim 14, wherein the surface protective resin member has a surface roughness Ra in a range of 0.2 μm to 10 μm.

16. The surface protective resin member according to claim 14, wherein the surface protective resin member is a resin film having an average thickness in a range of 5 μm to 100 μm.
